(19) United States
(12) Patent Application Publication
(10) Pub. No.: US 2017/0099647 A1
(43) Pub. Date: Apr. 6, 2017

(54) Systems and Methods for Registering Devices in a Wireless Network

(71) Applicant: Nebulae LLC, Marshall, TX (US)

(72) Inventors: Meet Shah, Anand (IN); Utpal Solanki, Anand (IN); Vaghela Tejas, Anand (IN)

(73) Assignee: Nebulae LLC, Marshall, TX (US)

(21) Appl. No.: 15/285,674

(22) Filed: Oct. 5, 2016

(30) Foreign Application Priority Data
Oct. 5, 2015 (IN) 3768/MUM/2015

(51) Int. Cl. H04W 60/04; H04W 12/06; H04W 12/08; H04L 29/06

(52) U.S. Cl. CPC H04W 60/04; H04L 63/101; H04L 63/0876; H04W 12/06; H04W 12/08; H04L 63/0823; H04W 4/008

(57) ABSTRACT

A wireless sensor network is disclosed. A content management system (CMS) communicates with a gateway over a network connection. The CMS operates with a registration service operating on a computer or mobile device. Under the control of the registration service the gateway may be registered on the WSN. Nodes seeking to register to the WSN must satisfy a two level validation process. A first level of validation involves comparing a network identifier and a media access control (MAC) key with values established during a factory setup of the node. A second level of validation involves a comparison of a MAC address of the node with a whitelist of authorized nodes stored in the gateway.

The following specification particularly describes the nature of this invention and the manner in which it is to be performed.

### FIELD OF THE INVENTION

The present invention relates to networks of interconnected devices such as nodes and gateways including wireless devices for application in what is known as the Internet of Things (IoT), and more particularly to the registration, network configuration, and security of uniquely identifiable, embedded computing, sensing and controlled devices operating under a wireless standard such as 802.15.4 Media Access Control.

### BACKGROUND OF THE INVENTION

The Internet of Things (“IoT”) generally refers to a network of physical objects or “things” that include sensors, electronics, software and connectivity so that the things can be connected with the Internet, directly or through connectivity with other things (connection with other things often being called machine-to-machine or M2M). This allows the various things to exchange data with each other and with devices or systems connected to the Internet so that manufacturers, operators, users and/or other connected things can exchange data, information and commands to carry out a desired process, service or activity. This allows objects to be sensed and controlled (i.e., turned on or off or up or down) remotely across one or more networks, and including based on M2M communications. The potential applications for IoT networks are almost limitless, and include applications such as smart cities and electrical grids, intelligent home and industrial automation systems, with the objects including things such as electric/gas/water meters, motors, pumps, sensors (light, temperature, pressure, etc.), thermostats, lights, wearable devices, home appliances such coffee makers and refrigerators, as well as anything that outputs electrical signals or can be controlled by receiving electrical signals.

To connect many objects to each other and to the Internet often is done by connecting devices into one or more networks, and then having one or more devices having Internet connectivity connect to the one or more networks of devices. This enables the devices to have a connection path to/from the Internet without each device having its own connection to the Internet. This enables devices to be lower in cost, lower in power consumption, smaller in size, etc., as compared to each device having the capability of being directly connected to the Internet. When connecting devices together, this can be by wired or wireless (e.g., radio-based) connections, with many applications requiring a wireless connection to be practical, cost effective, etc.

Devices (including, sensors, equipment, and components) that are connected to the Internet for purposes of monitoring and/or control must be uniquely identified to their monitoring or controlling systems. Registration is the process of identifying and authenticating the devices, and storing registration information that will enable secure communication with the devices. Registration information typically includes, but is not limited to, the type of device, device ownership, a device description, the device address(es) (IPv4, IPv6, MAC, etc.), communications protocol (e.g., radio channel information), and type of encryption for the communication data streams, and an encryption key.

In general, there are two classes of devices that must be registered: Gateways and Nodes. A Node may be an endpoint in a network, or it may connect to one or a plurality of other Nodes. If the Node connects to more than one network, it is referred to as a Gateway Node, or in its shortened form, as simply a Gateway.

To increase device and network security, and simplify the process of building a network of devices, it is desirable to support the automatic discovery, identification, and authentication of devices as they are connected to the network. This becomes more important as the number of devices in a network increases.

### SUMMARY OF THE INVENTION

The present invention describes systems and methods for registering devices preferably using a IEEE 802.15.4 MAC that is secure, with minimal manual intervention, and preferably provides automatic network discovery for registered devices. This registration process preferably can be used by any 802.15.4 radio.

During the Registration procedure, Gateways and Nodes are identified to the Registration System. Nodes are associated with the Gateway to which the Nodes will be connected. The Gateway stores a list of the Nodes that can be connected to the Gateway, a so-called whitelist. With few required user actions, authentic and authorized devices may be securely and reliably commissioned in a network. Factory setup for Gateways and Nodes, and a novel two level validation process help ensure secure commissioning.

As will be appreciated from the description of preferred and alternative embodiments included herein, substantial improvements and efficiencies are provided by the present invention. Generally in IoT applications, deployment of hundreds or even more devices can be a cumbersome and time consuming task (e.g., deploying hundreds of smart street lights in a city). In accordance with the present invention, deployment, from a user standpoint, can be an improved, hassle-reduced process where the user conducts a QR code scan and the intelligence of the devices carry out the desired operations to setup a secure and robust network of devices. Irrelevant of where and when the sensor node will be actually be deployed, with simple actions on the part of the user the device will appear in the desired cloud portal and will only be able to be commissioned a part of the desired network. In prior art approaches, there tended to be a need for multiple information exchanges between the to devices and the user that made the registration process time consuming, annoying and sometimes impractical for industry level solutions. In accordance with the present invention, QR scanning or similar easy user inputs may serve as ground layer invocation for necessary information exchange for commissioning that occurs in a secure manner without user intervention. Once the QR code is scanned, authentication and secure registering of a device is achieved by authentic devices preferably with little or no additional user input.

An object of the present invention is to allow commissioning of devices that, from a user perspective, that approaches “scan and forget,” with the intelligence and capabilities of the devices carrying out the necessary tasks for secure and reliable commissioning.

In addition, it is an object of the present invention that, while devices are in the registration process, be protected from security attacks. In accordance with the present invention, only genuine, authentic and authorized devices achieve successful commissioning in the desired network. The present invention serves to filter out false packet hammering or active sniffing or other attempts at unauthorized network access.

### BRIEF DESCRIPTION OF THE DRAWINGS

The advantages of the present invention will become more apparent by describing in detail the preferred embodiments with reference to the attached drawings in which:

FIG. 1A a diagram illustrated an IoT type network with cloud/Internet connectivity and controlling capability in accordance with an embodiment of the present invention.

FIG. 1B is a diagram illustrating a Gateway in accordance with an embodiment of the present invention.

FIG. 1C is a diagram illustrating a Node in accordance with an embodiment of the present invention.

FIG. 2 is a diagram illustrating Gateway factory setup in accordance with an embodiment of the present invention.

FIG. 3 is a diagram illustrating Node factory setup in accordance with an embodiment of the present invention.

FIG. 4 is a diagram illustrating user device cataloging in accordance with an embodiment of the present invention.

FIG. 5 is a diagram illustrating Gateway Registration in accordance with an embodiment of the present invention.

FIG. 6 is a diagram illustrating Node Registration in accordance with an embodiment of the present invention.

FIG. 7 is a diagram illustrating Node Authentication—Single Hop in accordance with an embodiment of the present invention.

FIG. 8 is a diagram illustrating Node Authentication—Multiple Hop in accordance with an embodiment of the present invention.

### DETAILED DESCRIPTION OF THE PREFERRED EMBODIMENTS

The present invention will be described in greater detail with reference to certain preferred and alternative embodiments. As described below, refinements and substitutions of the various embodiments are possible based on the principles and teachings herein.

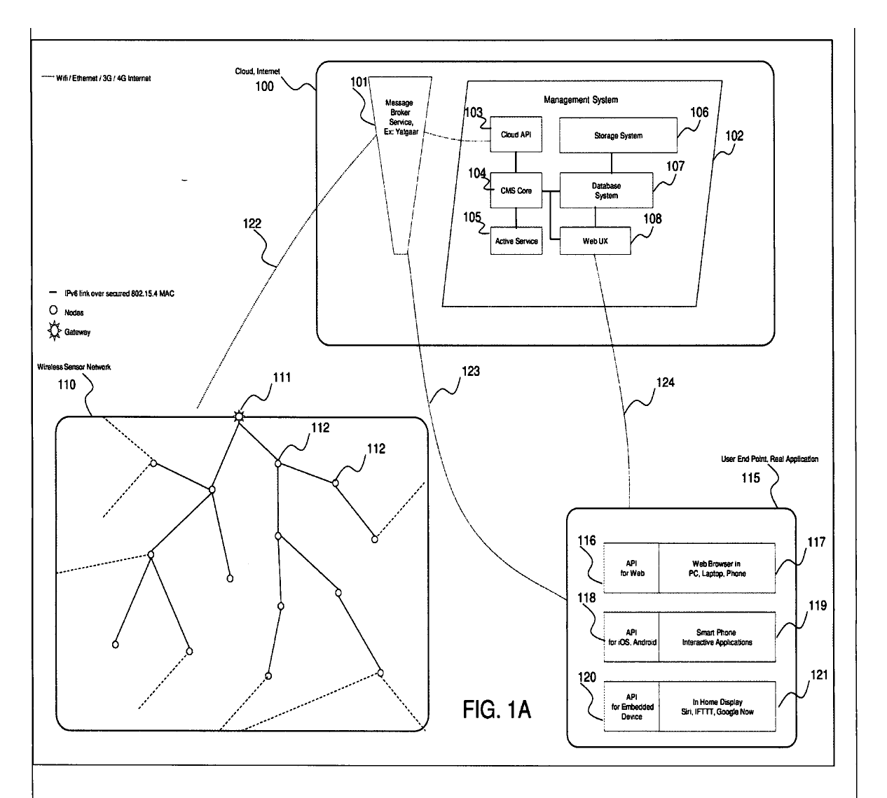

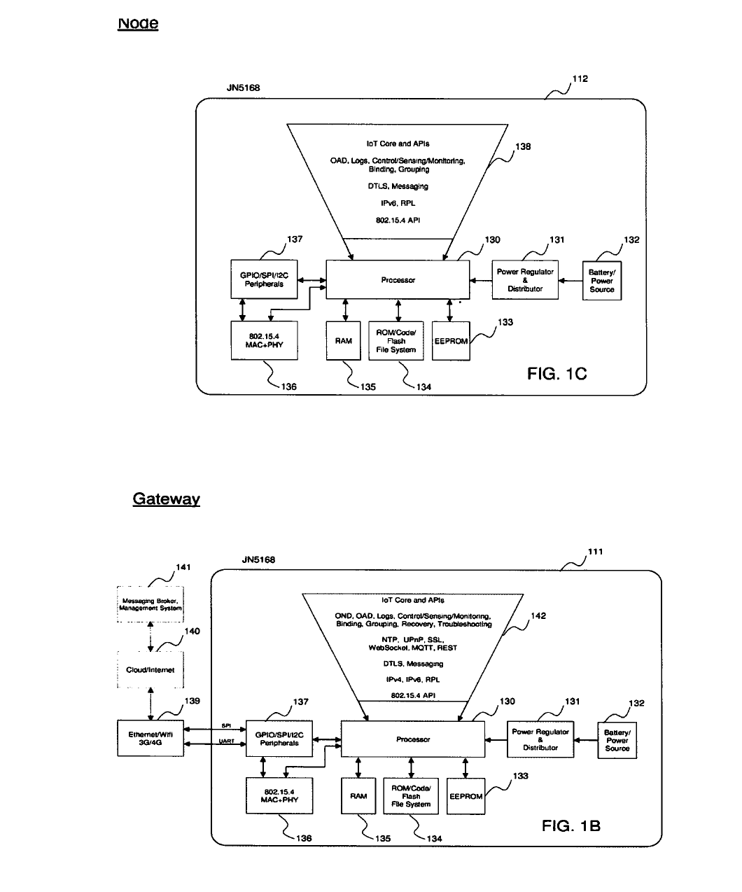

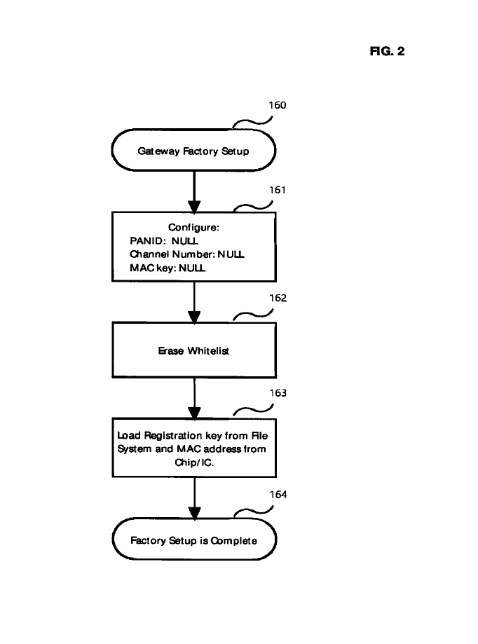

FIG. 1A illustrates an exemplary IoT network architecture in accordance with an embodiment of the present invention. Internet or cloud system 100 is connected to Wireless Sensor Network (WSN) 110 via network connection 122. Cloud system 100 as illustrated includes management system 102 (sometimes called a content management system or CMS) receiving communications from network connection 122 via message broker service 101. What is important is that cloud system 100 be able to receive and send data to WSN 100, which preferably are in the form of compact messages via a message broker service 101 (or other similar data/message communication service or capability included in cloud system 100). Cloud system 100 also preferably includes one or more cloud APIs 103 (Application Programming Interfaces) enabling communication with message broker service 101. Cloud API 103 serves as an interface to other exemplary components of management system 102. This includes: CMS core 104, which preferably is a web-based content management system enabling uses to access, view, store, modify and control data and files relating to devices including Gateways and Nodes and other systems accessible over a network coupled to the CMS, etc.; active service 105 (e.g., Javascript, which maintains latest data base and settings even if the user's network connection fails or the user is offline); database system 107; storage system 106; and web UX 108.

Web UX 108 (UX an acronym for User Experience) provides a user interface (UI) to cloud system 100, which preferably is connected to one or more user endpoint/application 115 over connection 124. Connection 124 may be any suitable connection(s) between a user endpoint/application 115, which may be a wired or wireless Internet connection or other connection to the user interface of web UX 108. What is important is that users have a system for interfacing with management system 102. User end point/application 115, in an exemplary configuration, includes: web API 116 coupled to web browser 117 (which may be a browser on a personal computer, laptop or mobile device such as a cellphone or tablet); API 118 (preferably for a mobile operating system such as Apple's iOS or Google's Android operating systems) coupled to smart phone 119 (or tablet), which can provide an application on the mobile devices that can interface with the user interface of web UX 108; API 120 (preferably for an embedded device) coupled to unit 121, which may be, for example, an in-home display unit, an intelligent personal assistant service such as Siri on an iOS device or Google Now on an Android device, or IFTTT (If This Then That) web service. User end point/application 115 also may communication messages to/from management system 102 via message broker service 101 over connection 103, as illustrated. What is important is that users may communication messages between user end point/application 115 and management system 102, and/or that user end point/application 115 provides a user application/service so that users can interact with management system 102 via the user interface of web UX 108. As will understood, connection 123 and 124 may be separate communication connections, or may be over a common network connection.

In accordance with certain preferred embodiments, user end point/application 115 provides a device and/or service for cataloging and registering Gateways and Nodes into a network such as WSN 110.

WSN 110 is one or more networks of sensors and/or other devices (Nodes) capable of sending and receiving data or other electrical signals to/from cloud system 100 over connection 122. In general, WSN 110 includes one or more units capable of communication with cloud system 100 via connection 122, and in general such units are illustrated by Gateway 111. While WSN 110 is illustrated with one Gateway 111, WSNs may include more than one Gateway 111 providing a connection to cloud system 100. WSN 110 also includes a plurality of Nodes 112, which may include a few or even hundreds or thousands of Nodes that connect to each other (as illustrated by the lines connecting nodes 112 in WSN 110, which preferably are wireless/radio connections), and which in a networked manner connect to gateway 111, which may then communicate with cloud system 100 over connection 122. In such a manner, a plurality of Nodes (which may be lower in cost, battery operated, etc.) may wirelessly connect with each other and directly or indirectly to Gateway 111 for communication with cloud system 100. Connection 122 may be, for example, an Internet connection provided in any desired manner, which may be by WiFi, cellular (2G, 3G, 4G, LTE, etc.), Ethernet, etc. What is important is that WSN 110 communicates with a plurality of Nodes 112 over a network connection 122 via one or more Gateways 111.

FIG. 1B illustrates an exemplary configuration of Gateway 111 (the present invention is not limited to this particular configuration). Exemplary Gateway 111 utilizes, for example, an NXP Semiconductor JN5168 wireless microcontroller, the data sheets and user manuals for which are hereby incorporated by reference. In other embodiments, other microcontrollers are utilized in Gateway 111.

As illustrated in FIG. 1B, exemplary Gateway 111 includes processor 130, which is powered by power regulator and distributor 131, receiving power from battery/power source 132. In preferred embodiments, battery/power source 132 is a battery providing the capability of Gateway 111 to be de-coupled from a wired power source, although in alternative embodiments (such as a power meter) Gateway 111 may receive electrical power via physical wires from a power source or electrical grid. Processor 130 is coupled to and can exchange data with EEPROM 133, ROM/Code Flash 134 and RAM 135, which are provided in Gateway 111 to provide sufficient data storage for gateway 111 to carry out its desired operations and functions. Processor 130 preferably exchanges data with exemplary radio MAC+physical layer 136, which as will be appreciated by those of skill in the art, provides a media access controller (MAC) and physical layer interface with a radio in Gateway 111 (as is known in the art, a MAC address is a unique identifier assigned by the hardware manufacturer to network interfaces for communications on a network). Although not shown in FIG. 1B, Gateway 111 may include an antenna coupled to MAC+physical layer 136 in order to radiate RF signals to nodes 112. What is important is that Gateway 111 includes circuitry and physical structure to provide an RF emitting capability for wirelessly communicating with nodes 112.

Also as illustrated in FIG. 1B, processor 130 couples data to/from interface circuit 137, preferably implements one or more GPIO/SPI/I2C peripheral interfaces so that Gateway 111 can communicate with network connection module 139, which provides network connectivity so that Gateway 111 can communicate with cloud system 140. This preferably is by way of messages processed by message broker/management system 141 as illustrated, and as an example cloud system 140 and message broker/management system 141 may be implemented as cloud system 100, message broker service 101 and management system 102, as discussed in connection with FIG. 1A. As illustrated in FIG. 1B, network connection 139 may be wired Ethernet (e.g., 802.3), wireless Ethernet or WiFi (e.g., 802.11), or cellular (2G, 3G, 4G, LTE, etc.) or other network connection. What is important is that Gateway 111 include internally or be coupled to a communication module such as network connection module 139 so that Gateway 111 has a network connection so that it can communicate to the Internet and a cloud system such as cloud system 140, 100.

Block 142 of FIG. 1B illustrates exemplary services/functions provided by software executed by processor 130 in conjunction with various other elements of Gateway 111 in accordance with embodiments of the present invention. Exemplary services/functions provided by processor 130 include: Core and base operations and APIs for gateway 111; OND (Over Network Download/Over Internet Download); OAD (Over Air Download); Logging functions; Control/Sensing/Monitoring functions; Binding functions (e.g., to particular nodes or gateways); Grouping (for group control, messaging, etc.); Recovery; Troubleshooting (software routines for diagnosing and/or resolving errors or problems]; NTP (Network Time Protocol); UPnP (Universal Plug n Play); SSL (Secure Sockets Layer); WebSocket; MQTT (MQ Telemetry Transport); REST (Representational State Transfer API); DTLS (Datagram Transport Layer Security); Messaging; IPv4; IPv6; RPL (IPv6 Routing Protocol for Low power and Lossy Networks); and 802.15.4 API.

Additional information regarding certain of such exemplary services/functions illustrated in FIG. 1B is as follows.

OND (Over Network Download/Over Internet Download); Gateway preferably is provided via the cloud a URL of a firmware update image to download. In the Gateway, preferably one process is invoked. The updated firmware image preferably is downloaded and stored in Flash. This firmware preferably has special bytes embedded in the firmware image, which can include firmware version, device type and MD5, and preferably data for confirming the authenticity and compatibility of the updated firmware before the update is applied.

OAD (Over Air Download); for Node firmware updates preferably this update service/block is added. In the Gateway, an updated firmware image for the Node is obtained via OND. As we there typically is a limitation on the RF payload length, in preferred embodiments the following mechanism is implemented. Nodes to be updated request blocks of updated firmware image from the Gateway. The Gateway preferably will reply with a specific block to a specific Node. For traffic reduction and fast updates, preferably there is a block preserving functionality, and there may be at least two different methods for OAD: N to N update (single), or N to Many update (more than one). This firmware also preferably has some special bytes embedded in the firmware image, which may include firmware version, device type and MD5, and preferably data for confirming the authenticity and compatibility of the updated firmware before the update is applied.

Binding; you can bind two different devices such as for making an action trigger mechanism (e.g., If This event Then That action, such as binding of a temperature sensor with a fan control); preferably Binding MIB is provided and the user can easily set binding rules; as is known in the art, a management information base (MIB) is a formal description of a set of network objects that can be managed using the Simple Network Management Protocol (SNMP), and the format of the MIB may be defined as part of the SNMP protocol.

Grouping; for group control or group binding.

Recovery; preferably, on power failure, or any network failure, the Gateway or Node will recover itself. Also, preferably a log is provided of network failure events and status, etc.

Messaging; preferably, a compact, efficient messaging service is provided, with a communication protocol for Nodes, Gateways and the cloud. A custom protocol (such as AIMs developed by Applicant) or a standard protocol like CoAP (Constrained Application Protocol), MQTT, JSON (JavaScript Object Notation) are used in preferred and alternative embodiments.

What should be appreciated is that Gateway 111 has hardware and software resources to carry out services and functions for communicating with a plurality of Nodes 112 (for control thereof, and communicating data to and from Nodes 112), and also communicate messages to/from cloud system 100.

Each Gateway 111 and each Node 112 preferably have associated therewith a network address, which preferably is an IP address. In preferred embodiments, IPv6 addresses are used for Gateways and Nodes. In preferred embodiments, each Gateway will be provided with a prefix that is provided from an Internet Service Provider (ISP) that will provide Internet access for the Gateway. Preferably, the Gateway forms an IPv6 address based on (prefix::<MAC>), which will be that Gateway's IPv6 address. When a Node has not yet been registered as part of a network, it preferably will self assign an IPv6 address using a link local address based on (fe80::<MAC>). When a Node is registered and becomes part of a network, it preferably will be provided a prefix from the Gateway (typically the same prefix as provided from the ISP) and the Node will create a IPv6 address from that prefix based on (prefix::<MAC>). Other IPv6 type address generation schemes may be used in alternative embodiments. As for communication with Nodes, in preferred embodiments Gateways preferably may use IPv6 unicast messages based on (aaaa::<MAC>), IPv6 anycast messages based on (ff02::<anycast_IP>), and IPv6 multicast messages based on (ff00::<multicast_IP>). Such IPv6 messaging and addressing techniques will be understood in the context of the present invention by those of skill in the art.

FIG. 1C illustrates an exemplary configuration of Node 112. Exemplary Node 112 utilizes, for example, an NXP Semiconductor JN5168 wireless microcontroller, the data sheets and user manuals for which are hereby incorporated by reference. In other embodiments, other microcontrollers are utilized in Nodes 112. As will be understood by those of skill in the art, WSN 110 could have a Nodes and Gateways using a variety of microcontrollers, provided that the Nodes and Gateways operate and communicate in a manner consistent with other Nodes and Gateways.

In certain preferred embodiments, Gateway 111 and Nodes 112 are implemented with common components/functions, as will be appreciated from a comparison of FIG. 1B with FIG. 1C, and an understanding of such common components/functions may be understood based on the discussion provided with respect to Gateway 111 and FIG. 1B. Similarly, Block 138 of node 112 illustrates exemplary services/functions provided by software executed by processor 130 in conjunction with various other elements of node 112. Such exemplary services/functions in general may be a subset of services/functions of gateway 111 discussed in conjunction with FIG. 1B and may be understood based on the previous discussion.

What should be appreciated is that Nodes 112 have hardware and software resources to carry out services and functions for communicating with other of Nodes 112 (for passing messages for control thereof, and communicating data to and from Nodes 112), and also communicate messages to/from Gateway 111. As will be appreciated from description elsewhere herein, in preferred embodiments such communications preferably are based on IPv6-based network communications, which may be over the Internet.

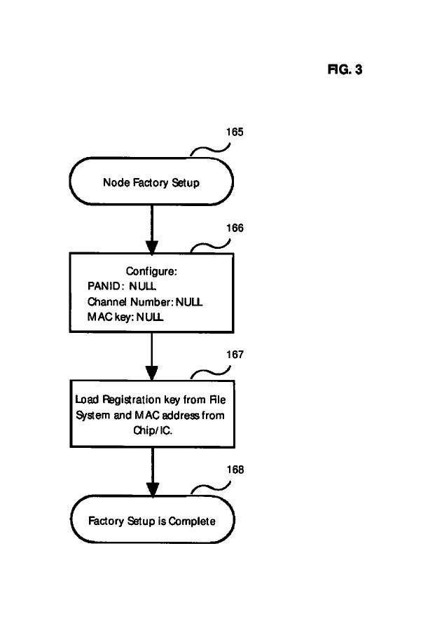

Initially, and as a part of the present invention's overall network security, Gateways and Nodes are setup in the factory (or similar pre-deployment environment) with certain stored information. Such stored information preferably is stored in what may be considered a file system, which may consist of EEPROM, Flash or other preferably non-volatile storage, that preferably will store desired information that is “flashed” during the production cycle or other pre-deployment processing. As illustrated in FIG. 2, Gateway factory setup is initiated at step 160. At step 161, parameters of the Gateway preferably are configured with default or initial values, such as PAN ID: NULL, Channel No.: NULL, and MAC Security Key: NULL. In preferred embodiments NULL values are all 1's or FF values, while in other embodiments other values may be used. Such values preferably are stored in the Gateway's file system. At step 162, the storage of the Gateway holding its Whitelist, preferably a predefined portion of the Gateway's file system, is erased to NULL values. This step is optional for Gateways that have not been previously utilized, but for previously utilized Gateways provides the benefit of erasing MAC addresses of previously configured Nodes that are no longer to be associated with that Gateway. At step 163, a Registration Key is loaded into the Gateway's working memory (e.g., RAM) from the Gateway's file system. This Fixed Key is utilized in the Node registration process and is used by the Gateway to decode (un-encrypt) registration messages coming from Nodes that attempt to register with the Gateway (this step is optional for factory setup). Also at step 163, a preferably 64-bit MAC address is retrieved from a chip/IC that is included as part of 802.15.4 MAC+physical layer 136. At step 164, the factory setup of the Gateway is completed. As will be appreciated, various testing operations may be performed before, during or after factory setup to ensure that the Gateway is operating satisfactorily, without defects, etc. Also as will be appreciated, while FIG. 2 is illustrated as a factory setup procedure, this procedure preferably may be invoked outside the factory such as by other pre-deployment processing or via a predetermined hardware reset operation after deployment in order to return the Gateway to a factory setup state.

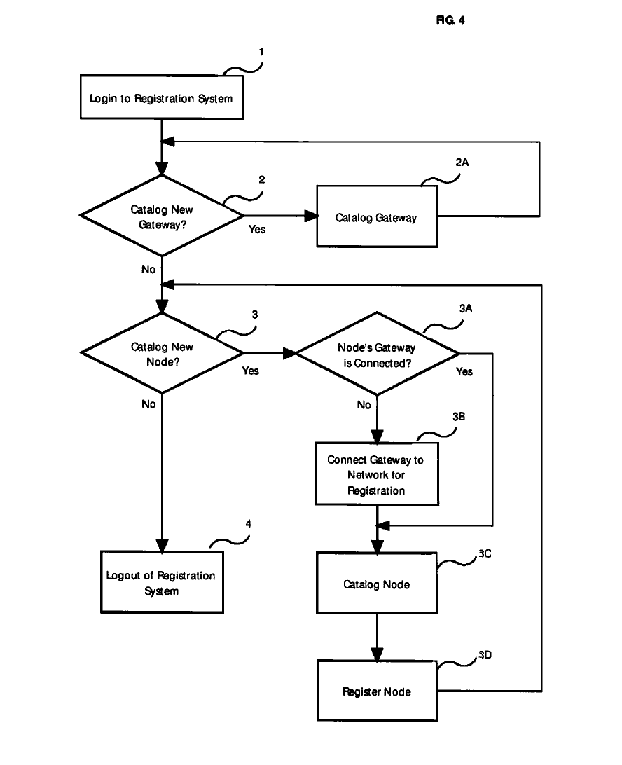

As illustrated in FIG. 3, Node factory setup is initiated at step 165. At step 166, parameters of the Node preferably are configured with default or initial values, such as PAN ID: NULL, Channel No.: NULL, and MAC Security Key: NULL. In preferred embodiments NULL values are all 1's or FF values, while in other embodiments other values may be used. Such values preferably are stored in the Node's file system. At step 167, a Registration Key is loaded into the Node's working memory (e.g., RAM) from the Node's file system. This Fixed Key is utilized in the Node registration process and is used by the Node to encrypt registration messages that are sent from the Node when it attempts to register with a Gateway (this step is optional for factory setup). Also at step 167, a preferably 64-bit MAC address is retrieved from a chip/IC that is included as part of 802.15.4 MAC+physical layer 136. At step 168, the factory setup of the Node is completed. As will be appreciated, various testing operations may be performed before, during or after factory setup to ensure that the Node is operating satisfactorily, without defects, etc. Also as will be appreciated, while FIG. 3 is illustrated as a factory setup procedure, this procedure preferably may be invoked outside the factory such as by other pre-deployment processing or via a predetermined hardware reset operation after deployment in order to return the Node to a factory setup state.

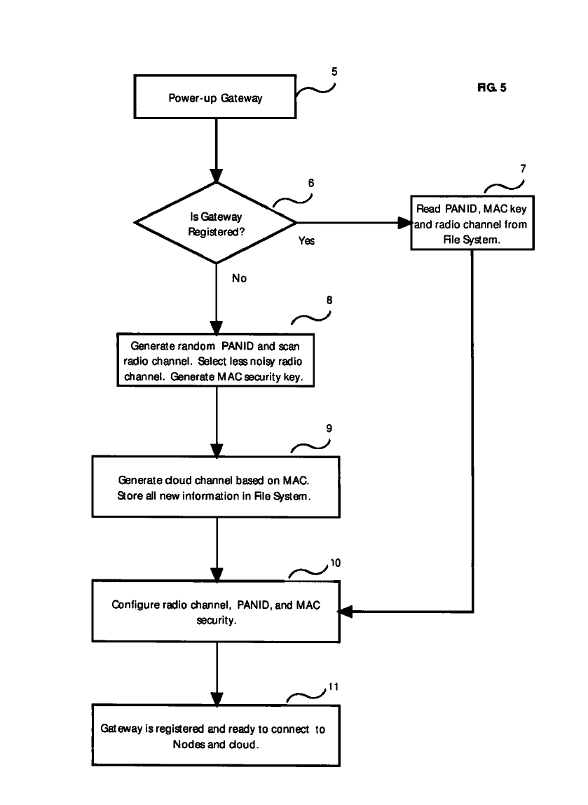

FIG. 4 is a diagram/flow chart of cataloging and registering devices in a Registration System in accordance with preferred embodiments of the present invention. In preferred embodiments, the Registration System is a device and/or service provided via user endpoint/application 115 discussed in connection with FIG. 1A, and in certain preferred embodiments is an application (app) running on a smart phone, tablet or other mobile device having a camera and scanning capability, the use of which will be described hereinafter.

A device in general may be a Gateway or Node. The user preferably logs into the to Registration System at step 1, for which the user has been provided with authenticated security credentials (e.g., user name and password, etc.). If at step 2 a new Gateway is to be cataloged, then at step 2A the Gateway's serial number is captured by the Registration System either by the user manually keying it into the system, or by scanning the Quick Response (QR) Code or Bar Code that preferably is supplied with the device (e.g., a camera and scanning app in a smart phone, tablet or other mobile device). Steps 2 and 2A are repeated until all Gateways for the user are cataloged. In preferred embodiments, cataloging is achieved based on a serial number, which preferably is generated based on the MAC address.

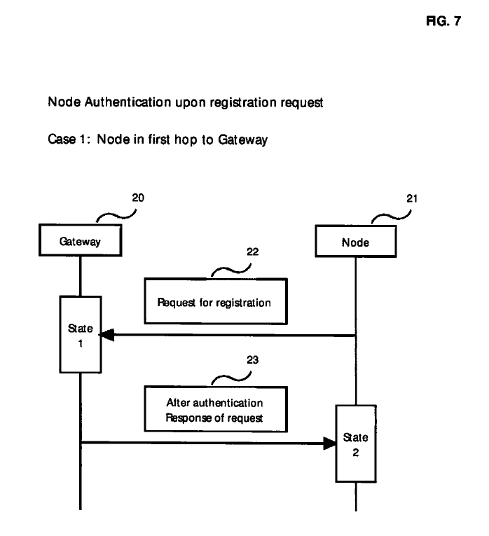

Once Gateway cataloging is complete, then Node cataloging and registration may begin. If a new Node is to be cataloged at step 3, and the Gateway to which the Node will be linked is connected to the network as determined at step 3A, then the Node may be cataloged at step 3C for connection to the Gateway either by the user manually keying the device's serial number into the Registration System, or by scanning the Quick Response (QR) Code or Bar Code that preferably is supplied with the device such as previously described in the description of the Gateway. Once the Node is cataloged, it may be connected to the network and registered at step 3D. A preferred procedure for step 3D is detailed in FIG. 6.

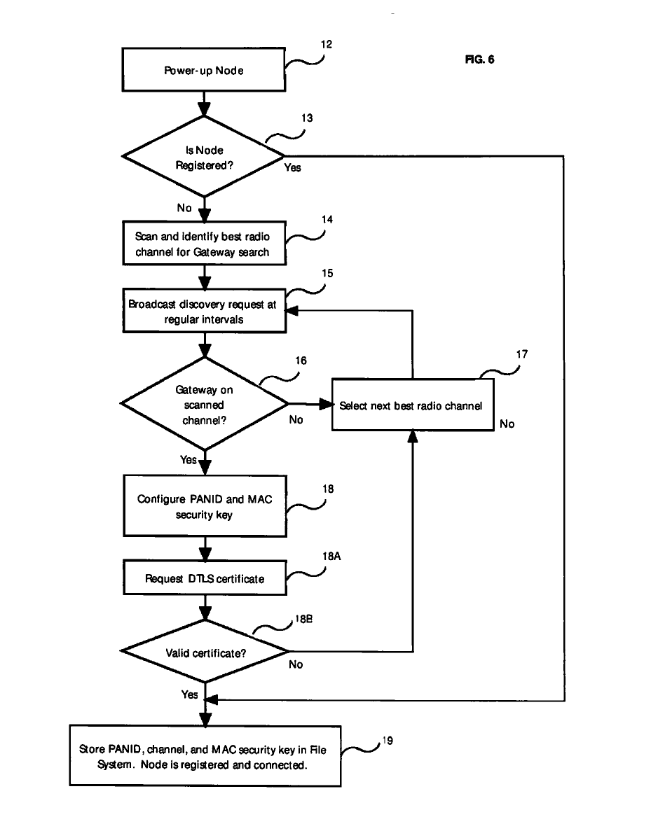

If the Gateway to which the new Node will be linked is not connected to the network as determined at step 3A, then the user powers-up and connects the Gateway to the network at step 3B. If the Gateway is not already registered, then the procedure in FIG. 5 preferably will automatically be performed. After the Gateway is registered, the Node may be cataloged at step 3C and registered at step 3D. Steps 3, 3A, 3B, 3C, and 3D are repeated until all Nodes are cataloged and registered.

Once all the Gateways and Nodes have been registered, the User preferably may log out of the Registration System at step 4.

FIG. 5 is a diagram of a preferred embodiment of a Gateway registration process, shown as step 3B in FIG. 4. When a Gateway is powered-up at step 5 and connected to the network, in preferred embodiments it will connect automatically to the Registration System via exchange of identifying data and commands, etc., between user end point/application 115 and management system 102 and the Gateway. The Gateway checks at step 6 its file system to determine if it is registered (as will be explained hereinafter, a registered Gateway has data stored in predefined locations, which may serve as an indication that the Gateway has been registered). If it is registered, the Gateway will retrieve at step 7 from its file system the Personal Area Network Identification (PANID), radio channel, and its AES-128 (Advanced Encryption Standard 128) key for MAC (Media Access Control) security. It will then configure at step 10 the radio channel, PANID, and MAC security for communication with the cloud. The Gateway is now registered and ready for Nodes to be connected as illustrated by the ready state of step 11. It should be noted that the present invention is not limited to AES-128 encryption, and in alternative embodiments other encryption algorithms and techniques may be utilized.

If the Gateway checks at step 6 its file system and determines that it is not registered, it will scan at step 8 radio channels and preferably detect the energy on each channel. It preferably will select the least noisy channel. Preferably using a random number generator, it will generate a PANID and AES-128 key for MAC security. Using the MAC address, a cloud security key is generated to establish a cloud channel. Preferably, the unique identification of the hardware provided by the MAC address is used as a key and encrypted to generate an encrypted key which will only be recognizable by the cloud system (as will be understood, a similar algorithm running in the cloud system will decode the encrypted key and look for a valid match with the MAC address that was used as the key), thereby establishing a secure cloud channel. After the cloud channel is created, the PANID and new AES-128 MAC key preferably will be stored in the Registration System, and also preferably stored at step 9 in the file system of the Gateway. The cloud channel will then be configured using the new cloud security key. The Gateway is now connected to the network and registered. The Gateway's Nodes may now be registered at step 11.

FIG. 6 is a diagram of a preferred embodiment of the Node registration process. When a Node is powered-up at step 12, the Node will check at step 13 its file system to determine if it is registered. If it is not registered, at step 14 the Node preferably will start scanning each channel, detect the energy on each channel, select the noisiest channel, and configure its MAC with the preferably predefined factory PANID and MAC security key for the Node registration process. For purposes of channel scanning, the Node preferably detects energy in each channel and in preferred embodiments calculates a detected energy by averaging RSSI values over eight symbols (128 μs). Thus, in preferred embodiments, the Gateway preferably chooses the least noisy channel based on such a detected energy value, while the Node preferably chooses a channel based on a descending order of more noisy channels. In preferred embodiments, Nodes can locate Gateways with fewer iterations, thereby improving performance of the process. At step 15, the Node preferably will then search for a Gateway on the selected channel by broadcasting a discovery message with its configured PANID at a predetermined interval, such as every four seconds. The discovery message time interval preferably is tuned and optimally selected based on network configuration and density.

A Gateway that receives this message preferably will respond only if it is connected to the network, registered, and the Node is listed in its catalog inventory. As will be appreciated by those of skill in the art, a Gateway such as described in connection with FIG. 1B may be store in its RAM 135 or EEPROM 133 an inventory of Nodes to which the Gateway or other Nodes may connect, defining a “white list” of Nodes that are authorized to connect to the network. This white list preferably is based on the unique MAC addresses of Nodes. This provides an additional layer of security that prevents unauthorized or unintended Nodes from connecting to the Gateway.

If a Gateway is not found at step 16, then the second-to-the noisiest radio channel will be selected and the Gateway search will continue at step 15.

If a Gateway is found at step 16, and the Node is cataloged for that Gateway, then the Gateway sends a confirmation message that is encrypted so that only the unregistered Node can decrypt it using a predefined PANID and MAC security key. The confirmation message contains the Gateway's PANID, MAC address, and MAC security key. The Node is configured at step 18 to use the new PANID and MAC security key provided by the Gateway. This information preferably is stored in the Node's EEPROM. The Node uses the new configuration to request a Datagram Transport Layer Security (DTLS) certificate at step 18A. If it receives a valid DTLS certificate from the DTLS server determined at step 18B, preferably using a cyclic redundancy check (CRC) alone or in combination with a Message Digest 5 (MD5) checksum, it stores the network configuration and DTLS certificate preferably with a lease time at step 19. In accordance with embodiments of the present invention, the DTLS certificate is generated by the Gateway using a random or pseudo-random number generator. The DTLS certificate provides a level of protection against an application layer type of hack. In preferred embodiments, the DTLS certificate is valid only until expiration of a lease time, at which time the Gateway generates new DTLS certificates for the Nodes. In accordance with preferred embodiments, the lease time provides a number of benefits. A hacker's task will be more difficult as upon expiration of the lease time all Nodes will change their application security key with an new DTLS certificate. In addition, the DTLS certificate preferably contains a current UNIX time stamp, which preferably is extracted and understood by all devices in the network. This allows improved time synchronization of the entire network (a time sync feature, in that all devices of the network can re-synch their internal clocks/timers upon receipt of the new DTLS certificate). If it does not receive a valid DTLS certificate at step 18B, it will select a new radio channel at step 17 (again preferably based on the next-lower noise channel) and begin searching for a new Gateway by broadcasting a new discovery message at step 15. The discovery message time interval preferably is tuned and optimized based on network configuration and density.

In accordance with preferred embodiments, a two level validation process is implemented. A first or local validation occurs when any registering node advertises its presence with a discovery message seeking network connectivity. Gateways or registered Nodes which receives this advertising via a discovery message perform a local authentication for this possible new Node. In the local authentication/validation, the Gateway or Node receiving the discovery message first confirms whether the new device seeking to join the network is presenting itself with the discovery message as an accurate and genuine Node. Such authentication helps to avoid black-box or packet replay attacks, for example. Unless the Node satisfies the local validation check, the discovery message is either not passed to the Gateway (if the receiving device is a registered Node) or not further processed if the receiving device is a Gateway. Only if local validation is satisfied will the discovery message be processed by a Gateway for the second level or global validation. In preferred embodiments, local validation preferably is carried out by assessing parameters such as: (1) Is the source MAC the same as written in the data payload of the message; (2) Is the source PANID and MAC key the same as defined in the factory setup; (3) Is the data payload frame consistent with the expected protocol for acceptable discovery messages. With such parameters, local validation can reject suspect Nodes.

In preferred embodiments, global validation preferably is performed at the Gateway level for all new registering Nodes. This validation helps avoid false registration of Nodes that may be from a legitimate source (e.g., a Node produced by a genuine manufacturer but intended for a different network). In other words, a registering device must connect only with a network to which it is intended to be connected. When a user scans the QR code on a device or enters its identifying information as described elsewhere herein, its registration information (e.g., MAC of that device) becomes available to a Gateway that is part of the intended network. When Global validation is requested for the registering device, if the Gateway successfully recognizes (validates) the device by findings its MAC address as corresponding to an entry in the Gateway's whitelist, then and only then will the Gateway respond to the request, which will including sending secure network credentials. In preferred embodiments, if the MAC address of the Node seeking registration is not present in the whitelist, the Gateway will simply ignore this request.

In the event that an unauthentic or unauthorized device tries to register with the network using false credentials or the like, this device generally will not be able to penetrate local validation. If a genuine device attempts to register to the where it is not authorized by having an entry on the whitelist, this device will not be able to penetrate Global validation.

Thus, with embodiments of the present invention, only if two layers of validation are achieved will the registering device be successful in being registered to or commissioned into the network. At the other end, if a registering device fails to achieve local validation and global validation in sequence, it will keep searching for a valid network indefinitely.

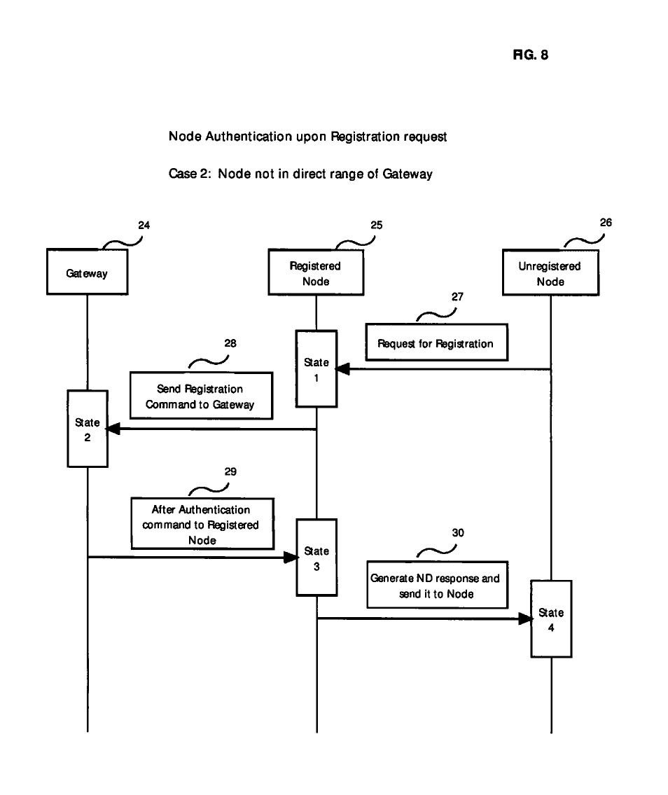

FIG. 7 is a diagram of the Node registration process in the case of the Node being in direct range of a Gateway, which means that the Node and Gateway are separated by one communications hop. When an unregistered Node 21 broadcasts discovery message 22 on a Gateway's radio channel to request registration, the Gateway 20 preferably receives and decrypts the message with the factory predefined MAC security key for the registration process (illustrated as State 1 in FIG. 7). The Gateway preferably compares the MAC frame source address and payload. If the Gateway finds the discovery message faulty (i.e., the discovery message does not satisfy the pre-determined protocol parameters for discovery messages), then it preferably will drop the discovery message. Otherwise, the Gateway will then validate the discovery message. If validation fails, then it will drop the message. If the discovery message validates, the Gateway will verify that the Node is in the Gateway's cataloged inventory list preferably based on MAC address, which was added by the user in step 3C of FIG. 4. Only if the Node has been cataloged for the Gateway, will the Gateway respond the Node with a discovery confirmation message 23 (illustrated as State 2 in FIG. 7).

FIG. 8 is a diagram of the Node registration process for a Node 26, which is not in direct radio range of Gateway 24, but is in radio range of one or more Nodes 25 which have already been registered into the Gateway's network. Only registered Nodes 25 will participate in the registration of a new Node.

Node 26 broadcasts a discovery message 27 that is received by Node 25, it being understood that a plurality of Nodes may receive and respond to discovery message 27. Node 25 preferably compares the message's long address with the payload and registration prefix. If the receiving Node 25 finds the discovery message faulty (i.e., the discovery message does not satisfy the pre-determined protocol parameters for discovery messages), then it preferably will drop the discovery message.

If the discovery message 27 is found to be valid, then Node 25 forwards the discovery message 27 to Gateway 24 for Node authentication 28. This message to the Gateway preferably is encrypted using both DTLS and MAC security. The Gateway will check its inventory for Node authenticity preferably based on MAC address. If it does not find unregistered Node 26 in its cataloged inventory, then preferably it will not respond to the discovery message. If the discovery message is found to be from a Node that is in the Gateway's cataloged inventory, then the Gateway will respond to registered Node 25 with a discovery confirmation message 29. Upon receipt of this discovery confirmation message 29, registered node 25 will generate a discovery confirmation message 30 and send it to unregistered node 26. In the case where multiple Nodes receive and respond to discovery message 27, Gateway 24 preferably will only respond to the responding Node that has an indication of highest or best signal strength or quality of the responding Nodes, such as by Gateway 24 comparing signal strength values accompanying messages from the responding Nodes (e.g., RSSI values, or relative received signal strength in a wireless environment, in arbitrary units, with the higher the RSSI number, being the stronger the signal).

Upon receipt of the discovery confirmation message, Node 26 will validate the authenticity of the message, and if confirmed, store the Gateway's radio channel, MAC security key, and PANID in its storage. Then Node 26 will request a DTLS certificate for Gateway's authentication as in step 18A of FIG. 6.

Although the invention has been described in conjunction with specific preferred and other embodiments, it is evident that many substitutions, alternatives and variations will be apparent to those skilled in the art in light of the foregoing description. Accordingly, the invention is intended to embrace all of the alternatives and variations that fall within the spirit and scope of the appended claims. For example, it should be understood that, in accordance with the various alternative embodiments described herein, various systems, and uses and methods based on such systems, may be obtained. The various refinements and alternative and additional features also described may be combined to provide additional advantageous combinations and the like in accordance with the present invention. Also as will be understood by those skilled in the art based on the foregoing description, various aspects of the preferred embodiments may be used in various subcombinations to achieve at least certain of the benefits and attributes described herein, and such subcombinations also are within the scope of the present invention. All such refinements, enhancements and further uses of the present invention are within the scope of the present invention.

What is claimed is:

1. A wireless sensor network (WSN) comprising:
a content management system (CMS) communicating over a network connection, wherein the CMS operates with a registration service;
at least one gateway in data communication with the CMS via the network connection, wherein the gateway is selectively registered as part of the WSN via operation of the registration service, wherein the gateway includes a radio transceiver for communication with nodes of the WSN;
a plurality of nodes coupled to the gateway, wherein each of the nodes has a radio transceiver for communication with the gateway;
wherein an individual node may join the WSN only after a two level validation process;
wherein a first level of validation is made based on whether the individual node presents a discovery message having a media access control (MAC) key and network identifier that is determined at the time of factory setup of the individual node;
wherein a second level of validation is performed if the first level of validation is satisfied, wherein the second level of validation is satisfied if the gateway determines that a MAC address of the individual node corresponds with a MAC address in a whitelist of authorized nodes that is stored in the gateway.

2. The network of claim 1, wherein under control of a processor the gateway determines a radio channel for communications with the plurality of nodes from a plurality of radio channels, wherein the processor determines the radio channel for communications with the plurality of nodes based on a noise parameter for each channel of the plurality of radio channels.

3. The network of claim 2, wherein the determined radio channel is selected based on a less noisy radio channel.

4. The network of claim 2, wherein under control of a processor each of the nodes determines a radio channel for communications with the gateway from a plurality of radio channels, wherein the processor determines the radio channel for communications with the gateway based on a noise parameter for each channel of the plurality of radio channels.

5. The network of claim 2, wherein the determined radio channel is selected based on a most noisy radio channel.

6. The network of claim 1, wherein the gateway communicates with the plurality of nodes based on a communications security certificate.

7. The network of claim 6, wherein the gateway communications security certificate includes a parameter for a predetermined lease time.

8. The network of claim 7, wherein the communications security certificate is re-issued after expiration of the predetermined lease time.

9. The network of claim 8, wherein the communications security certificate comprises a DTLS certificate.

10. The network of claim 8, wherein the re-issued communications security certificate includes data indicative of a time value, wherein the re-issuance of the communications security certificate provides time synchronization for the plurality of nodes with the gateway.
